(19) United States
(12) Patent Application Publication
(10) Pub. No.: US 2013/0237888 A1
(43) Pub. Date: Sep. 12, 2013

(54) PORTABLE, MANUALLY-OPERATED, SELF-MASSAGING APPARATUS FOR BACK ANATOMY

(71) Applicant: Pini A. Weinstein, Gretna, LA (US)

(72) Inventor: Pini A. Weinstein, Gretna, LA (US)

(21) Appl. No.: 13/417,183

(22) Filed: Mar. 9, 2012

(51) Int. Cl. A61H 7/00

(52) U.S. Cl. 601/137

(57) ABSTRACT

A portable, manually-operated, self-massaging apparatus for use on a human back anatomy includes a cylindrical head having a first vertical semi-cylindrical section continuously formed with a second vertical semi-cylindrical section, and a handle connected to the cylindrical head for forming a unitary construction. The handle includes a smooth rounded tip for providing a localized massage directly at a pain trigger point. The first vertical semi-cylindrical section includes a stationary smooth outer surface for providing a less intensive massage. The second vertical semi-cylindrical section includes rows of stationary wedge-shaped protuberances with each protuberance having a flat top for providing a deep tissue massage when applied to a human back anatomy. In an alternative embodiment, the top surface of the cylindrical head exhibits a smooth upper surface to facilitate neck and upper back massage.

### BACKGROUND OF THE INVENTION

1. Technical Field

The present invention relates to therapeutic devices. More specifically, the present invention relates to methods and apparatus for a portable, manually-operated, self-massaging apparatus having an extended handle and a cylindrical head, and more particularly to a cylindrical head having opposing semi-cylindrical sections for facilitating either a shallow, less intrusive massage or a robust deep tissue massage when applied to the human back anatomy.

2. Background Art

Therapeutic devices have been known in the fields of massage and chiropractic for many years. As an example, many modern chiropractic centers include staff personnel licensed to perform chiropractic manipulation utilizing therapeutic devices such as, for example, a hand-held “activator” employed for adjusting and aligning the human spine. Likewise, staff personnel licensed to perform massage therapy are commonly available to perform manipulation on the human muscular system subsequent to a chiropractic adjustment. Much of the massage therapy is performed by hand without the use of therapeutic devices but the use of therapeutic devices during massage therapy is common.

The prior art is replete with therapeutic devices that have been developed for use in administering massage to the human muscular system. Many of the massage devices known in the prior art were intended for use in administering massage therapy to the individual patient. Several references discovered by the Applicant will now be briefly discussed to assist in the understanding of the prior art relating to massage devices. In U.S. Pat. No. 6,878,124 issued to Crowe on Apr. 12, 2005, a massage apparatus is disclosed for providing rolling massage of skin zones and reflex zones of the human body. The massage device comprises a handle that defines a blind bore, and a shaft removably mounted to the handle. A plurality of freely rotatable massage rings are mounted on the shaft, each massage ring having spaced teeth distributed uniformly around its circumference with each massage ring to being spaced apart by a smaller diameter massage ring. Spacer washers are positioned at the ends of the aligned massage rings and mounted on the shaft adjacent the handle and the shaft head flat rear surface.

In U.S. Pat. No. 5,458,561 issued to Schweisfurth on Oct. 17, 1995, a massage device for the rolling massage of skin areas and reflex zones of the human body is disclosed which includes a shaft mounted on a handle and massage rings or rolling bodies which are freely rotatably mounted on the shaft. The massage rings or rolling bodies have projections which are uniformly distributed in circumferential direction. Preferably, the projections are needle tips. A connection is provided between the shaft supporting the massage rings or rolling bodies and the handle which is elastically yielding or resilient at least to a limited extent.

In U.S. Pat. No. Des. 304,974 issued to Helligenstein on Dec. 5, 1989, a Massager is disclosed showing a generally cylindrical construction attached to a handle for manipulating the massager. The cylindrical portion of the Massager appears to have irregularities formed thereon and a mushroom-shaped terminal end.

In U.S. Pat. No. Des. 376,853 issued to Hsia on Dec. 24, 1996, a Massager is disclosed generally showing a massaging instrument having an elongated head with irregularities formed thereon and a handle for maneuvering the massager.

In U.S. Pat. No. Des. 414,875 issued to Sirois et al. on Oct. 5, 1999, a Portable Body Massager is disclosed having a massager head including a plurality of oppositely directed irregularities formed thereon. The massage head construction tapers into a handle and appears to have an on-off switch for activating the Body Massager.

In U.S. Pat. No. D438,308 S issued to Harris et al. on Feb. 27, 2001, a Hand Held Massager With Rotatable Head is disclosed having a generally triangular-shaped head connected to a curved handle shaped to fit a human hand. The triangular-shaped head appears to have irregularities formed thereon and a switch for activating the Hand Held Massager.

In U.S. Pat. No. D531,733 S issued to Burout, III et al. on Nov. 7, 2006, a Massager is disclosed having a massaging head attached to a handle. The massaging head appears to have a mushroom-shaped projection mounted thereon in addition to irregularities formed thereon. The handle has an opening formed therein to facilitate holding the Massager and a switch for activating the Massager.

In U.S. Pat. No. D639,974 S issued to Kurosu et al. on Jun. 14, 2011, a Massage Roller is disclosed comprising a rectangular frame positioned at the terminal end of a handle. A set of five rollers having irregularities formed thereon are mounted within the rectangular frame and appear to be arranged to facilitate rotational motion of the five rollers.

In U.S. Pat. No. D643,540 S issued to Jian et al. on Aug. 16, 2011, a Roller Massager is disclosed having a spool-like construction including a central cylindrical body and a pair of end caps. Formed on the central cylindrical body is a plurality of small conical-shaped projections.

Notwithstanding, the prior art discovered does not disclose a portable, manually-operated, self-massaging apparatus for use on the human back anatomy that enables massaging difficult to reach areas of the back anatomy and includes two massaging surfaces formed on a cylindrical head construction that facilitates providing either a shallow, less intensive massage or a deep tissue massage.

Thus, there is a need in the art for therapeutic devices, particularly a portable, manually-operated, self-massaging apparatus for use on the human back anatomy which includes (1) a cylindrical head having a first vertical semi-cylindrical section that is continuously formed with (2) a second vertical semi-cylindrical section, (3) an extended handle connected to the cylindrical head for forming a unitary construction where the handle includes (4) a smooth rounded tip for providing a localized massage, where (5) the first vertical semi-cylindrical section includes a stationary smooth outer surface for providing a shallow, less intensive massage, and (6) the second vertical semi-cylindrical section includes (7) a plurality of rows of stationary wedge-shaped protuberances (8) with each protuberance having a flat top for providing a deep tissue massage when applied to a human back anatomy.

### DISCLOSURE OF THE INVENTION

Briefly, and in general terms, the present invention provides a new and improved portable, manually-operated, self-massaging apparatus for use in massaging difficult to reach areas of the human back anatomy. The self-massaging apparatus is of unitary construction and can be manipulated by the person being massaged to reach most locations of the human back anatomy. The self-massaging apparatus does not utilize any source of electrical or non-human mechanical power, is conveniently portable, and includes two massage surfaces positioned on a cylindrical head construction that enable a user to administer either a robust deep tissue massage or a more shallow, less intensive massage. The unique design of an exemplary embodiment of the present invention enables a person to utilize the invention as a portable, self-massaging instrument to address deep tissue muscle contractions primarily in the shoulders and the back anatomy. Because of the portable construction of the present invention, it can be maneuvered and manipulated to treat almost any area of the back or shoulder anatomy.

The self-massaging apparatus includes a cylindrical head and an extended handle. More particularly, the cylindrical head includes opposing vertical semi-cylindrical sections for massaging the human back anatomy. The extended handle is connected to the cylindrical head by, for example, injection molding for forming a unitary construction. However, the entire self-massaging apparatus including the cylindrical head and the extended handle can be fashioned from, for example, a single piece of wood. Furthermore, the distal free end of the extended handle includes a smooth rounded tip which can be useful for providing a localized massage such as, for example, a trigger point massage. The unique construction of the portable, self-massaging apparatus includes a first vertical semi-cylindrical section having a stationary smooth outer surface which facilitates a shallow, less intrusive massage. In contrast, an opposing second vertical semi-cylindrical section has a plurality of rows of stationary wedge-shaped protuberances that facilitate a deep tissue massage when applied to a human anatomy.

The wedge-shaped protuberances of the second vertical semi-cylindrical section are formed on the opposite side of the first vertical semi-cylindrical section when viewed from the bottom of the cylindrical head. The wedge-shaped protuberances preferably comprise, for example, six protuberances formed on the outer surface of the second vertical semi-cylindrical section across an invisible plane passing vertically through the cylindrical head and comprising approximately one-hundred and eighty mechanical degrees of the circumference of the cylindrical head. Depending upon the number of protuberances and the size of the angles located between the invisible plane passing vertically through the cylindrical head and the two end protuberances, the average angle between adjacent protuberances is within the range of twenty degrees-to-thirty degrees. The use of a wedge-shape for each of the protuberances is preferred because the wedge-shaped design provides a stiffer more robust deep tissue massage when compared to conical-shaped designs. Further, each of the wedge-shaped protuberances includes a flat top which does not exhibit the sharp edges resulting in a higher comfort level when the wedge-shaped protuberances are pressing on the human back anatomy.

Additionally, the plurality of rows of the wedge-shaped protuberances are stationary. This refers to the aspect that the protuberances formed on the second vertical semi-cylindrical section are molded into place and do not move. Consequently, during use of the self-massaging apparatus by the user, the protuberances will remain solid and robust and provide the deep tissue massage as anticipated. During use, the person utilizing the invention employs the extended handle to position the cylindrical head of the self-massaging apparatus at the situs of the back pain. If a deep tissue massage is desired, the wedge-shaped protuberances of the cylindrical head are aligned over the selected area of the back anatomy by utilizing the extended handle. The smooth outer surface of the first vertical semi-cylindrical section can be placed for support against a piece of furniture, a bed or a wall surface. The user can now manipulate her movements and body weight and the extended handle of the self-massaging apparatus to massage the deep tissues located at the selected area of her back anatomy. The cylindrical head can be caused to move horizontally or vertically on the back anatomy approximately three inches in either direction.

Thus, after the self-massaging apparatus is positioned on the back anatomy, the user can move in either a forward of backward direction, or move from a right-to-left position (or visa versa) depending upon the position of the cylindrical head. In this manner, the wedge-shaped protuberances are applied to a specific area of the back anatomy. The position of the cylindrical head on the back anatomy must be changed by the user to accommodate a change in the direction of the movement of the cylindrical head (and consequently the direction of the massage). If a more shallow, less intensive massage is desired, the extended handle is employed to rotate the self-massaging apparatus so that the smooth outer surface of the first vertical semi-cylindrical section is positioned against the back anatomy. Under these conditions, the wedge-shaped protuberances of the second vertical semi-cylindrical section are positioned against the furniture or wall surface. Once again, the users body weight in combination with the extended handle can be maneuvered in order to position the self-massaging apparatus to the desired location of the users back anatomy. Direct pressure and suitable movement of the user's body weight can then be applied so that the back anatomy traps the self-massaging apparatus between the user and a piece of furniture to achieve the desired massaging result. Once again, the self-massaging apparatus must be re-positioned by the user to change the direction of the massage. Note that the movements and maneuvering of the self-massaging apparatus is accomplished by manual operation. Further, the smooth rounded tip on the distal free end of the extended handle is useful to provide a localized massage to pain trigger points located on the back anatomy. This action may require the assistance of a third party.

The present invention is generally directed to a portable, manually-operated, self-massaging apparatus for use on a human back anatomy. The self-massaging apparatus includes a cylindrical head having a first vertical semi-cylindrical section continuously formed with a second vertical semi-cylindrical section. A handle is connected to the cylindrical head of the self-massaging apparatus for forming a unitary construction. The handle includes a smooth rounded tip for providing a localized massage directly at a pain trigger point. The first vertical semi-cylindrical section includes a stationary smooth outer surface for providing a shallow, less intensive massage. The second vertical semi-cylindrical section includes a plurality of rows of stationary wedge-shaped protuberances with each protuberance having a flat top for providing a deep tissue massage when applied to a human back anatomy.

An alternative embodiment of the present invention includes a cylindrical head having opposing vertical surfaces formed on opposite sides of a plane passing vertically through the cylindrical head. As with the preferred embodiment, the opposing surfaces include (1) a first vertical semi-cylindrical section having a stationary smooth outer surface for providing a shallow, less intensive massage, and (2) a second vertical semi-cylindrical section having a plurality of rows of stationary wedge-shaped protuberances for providing a more robust deep tissue massage. Further, the cylindrical head is connected, as by injection molding, to an extended handle for providing a unitary construction. In the alternative embodiment, the top surface of the cylindrical head exhibits a smooth upper surface to facilitate massage of the neck and upper back area of the human back anatomy.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a perspective view of a portable, manually-operated, self-massaging apparatus for back anatomy showing an extended handle connected to a cylindrical head which is positioned to disclose a first vertical semi-cylindrical section which exhibits a stationary smooth outer surface for providing a shallow, less intensive massage to the back anatomy of a human being.

FIG. 2 is a perspective view of the self-massaging apparatus of FIG. 1 showing an extended handle connected to a cylindrical head which is positioned to disclose a second vertical semi-cylindrical section which exhibits a plurality of rows of stationary wedge-shaped protuberances with each protuberance having a flat top for providing a deep tissue massage to the back anatomy of a human being.

FIG. 3 is another perspective view of the cylindrical head of the self-massaging apparatus of FIG. 1 positioned to show the smooth outer surface of the first vertical semi-cylindrical section.

FIG. 4 is yet another perspective view of the cylindrical head of the self-massaging apparatus of FIG. 1 positioned to show the plurality of rows of stationary wedge-shaped protuberances of the second vertical semi-cylindrical section.

FIG. 5 is a bottom plan view of the cylindrical head of the self-massaging apparatus of FIG. 1 showing the stationary smooth outer surface of the first vertical semi-cylindrical section, and the rows of stationary wedge-shaped protuberances of the second vertical semi-cylindrical section.

FIG. 6 is a perspective view of the self-massaging apparatus of FIG. 1 showing the unitary construction of the handle and the cylindrical head including the first vertical semi-cylindrical section having the stationary smooth outer surface, and the second vertical semi-cylindrical section having the rows of stationary wedge-shaped protuberances.

FIG. 7 is a perspective view of an alternative embodiment of a portable, manually-operated, self-massaging apparatus for back anatomy showing an extended handle connected to a cylindrical head having a smooth upper surface and positioned to disclose a second vertical semi-cylindrical section which exhibits a plurality of rows of stationary wedge-shaped protuberances.

FIG. 8 is another perspective view of the cylindrical head of the self-massaging apparatus of the alternative embodiment of FIG. 7 positioned to show the smooth upper surface of the cylindrical head cooperating with the plurality of rows of stationary wedge-shaped protuberances of the second vertical semi-cylindrical section.

FIG. 9 is a perspective view of the cylindrical head of the self-massaging apparatus of the alternative embodiment of FIG. 7 positioned to show the smooth upper surface of the cylindrical head cooperating with stationary smooth outer surface of the first vertical semi-cylindrical section.

### DETAILED DESCRIPTION OF THE INVENTION

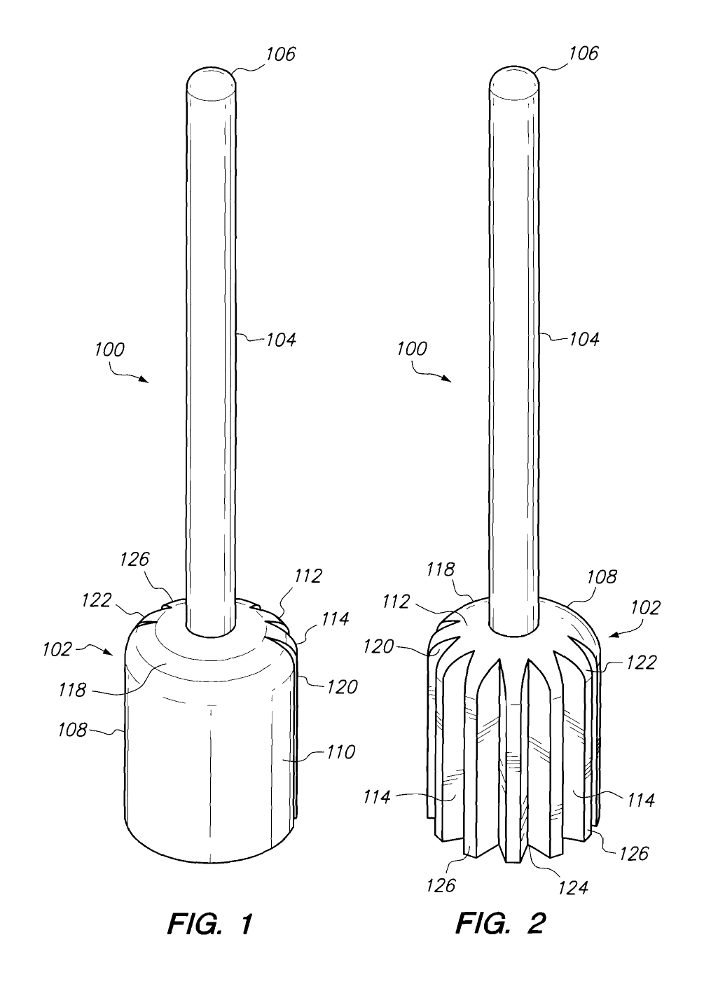

The present invention relates to a portable, manually-operated, self-massaging apparatus 100 for use on the back of a human anatomy as shown in FIGS. 1-9. In particular, the portable, manually-operated, self-massaging apparatus 100 is intended for use in massaging difficult to reach areas of the human back anatomy. The self-massaging apparatus 100 is of unitary construction and can be manipulated by the person being massaged to reach most locations of the human back anatomy. The self-massaging apparatus 100 does not utilize any source of electro-mechanical power, is conveniently portable, and includes two massage surfaces positioned on a cylindrical construction that enables a user (not shown) to administer either a robust deep tissue massage or a more shallow, less intensive massage. The unique design of the present invention enables a person to utilize the invention as a portable, self-massaging instrument to address deep tissue muscle contractions primarily in the shoulders and the back anatomy. Because of the portable construction of the present invention, it can be maneuvered and manipulated to treat almost any area of the back or shoulder anatomy.

In a preferred embodiment illustrated in FIGS. 1-6, the present invention is directed to the self-massaging apparatus 100 which includes a cylindrical head 102 and an extended handle 104 joined in a unitary construction. More particularly, the cylindrical head 102 includes opposing vertical semi-cylindrical sections as shown in FIGS. 1-6 for massaging the human back anatomy. The extended handle 104 is connected to the cylindrical head 102 by, for example, injection molding for forming the unitary construction. The entire self-massaging apparatus 100 including the cylindrical head 102 and the extended handle 104 can be comprised of any of a suitable class of synthetic materials which may be slightly flexible for shock absorption. However, the entire self-massaging apparatus 100 including the cylindrical head 102 and the extended handle 104 can be fashioned from other materials, for example, a suitable wood.

Furthermore, a distal free end of the extended handle 104 includes a smooth rounded tip 106 which can be useful for providing a localized massage such as, for example, a trigger point massage. The unique construction of the portable, manually-operated, self-massaging apparatus 100 includes the cylindrical head 102 which consists of continuously formed but opposing vertical semi-cylindrical sections. By “continuously formed”, it is meant that the opposing vertical semi-cylindrical sections form a complete vertical cylinder having two separate but opposing faces. The semi-cylindrical sections include a first vertical semi-cylindrical section 108 having a stationary smooth outer surface 110 for facilitating a shallow, less intrusive massage as is clearly illustrated in FIGS. 1, 3, 5 and 6. In contrast, an opposing second vertical semi-cylindrical section 112 has a plurality of rows of stationary wedge-shaped protuberances 114 as shown in FIGS. 1, 2, 4, 5 and 6 that facilitate a deep tissue massage when applied to a human anatomy (not shown).

A description of each of the main components of the self-massaging apparatus 100 will now be presented. The main components include the cylindrical head 102 and the extended handle 104 as shown in FIGS. 1, 2 and 6. The self-massaging apparatus 100 can be fashioned from any suitable material. The primary criteria is that the two components comprise a single member, that is, be of a unitary construction. The construction material should be fashioned from a firm material which may be slightly flexible. The firm material provides the cylindrical head 102 with the firmness necessary to apply adequate pressure to the back anatomy while also providing a slight flexibility to the extended handle 104. A slight flexibility to the extended handle 104 might be desirable in situations during which the extended handle 104 is utilized to strike the stationary smooth outer surface 110 of the first vertical semi-cylindrical section 108 of the cylindrical head 102 against the back anatomy. The slight flexibility in the extended handle 104 allows for shock absorption when the cylindrical head 102 is used to strike the back anatomy of a human being.

These fundamental requirements of the suitable material of the self-massaging apparatus 100 can be satisfied by any number of modern plastic materials which are amenable to mass production via injection molding or other similar methods. The requirement of a firm material exists because the self-massaging apparatus 100 is manipulated and positioned on the back anatomy by the extended handle 104 which is typically within the range of 9″-to-12″ in length. Thus, the extended handle 104 must be fashioned from a suitable robust material with sufficient strength to withstand the vigorous massaging of the various difficult to reach body parts of the back anatomy. The extended handle 104 enables the self-massaging apparatus 100 to be maneuvered not only to most areas of the back anatomy but is also utilized to rotate the cylindrical head 102 to change the massage mode. Reference to changing the massage mode refers to, for example, changing from the stationary smooth outer surface 110 of the first vertical semi-cylindrical section 108 which provides the less intensive massage to the back anatomy as shown in FIG. 1, to the rows of stationary wedge-shaped protuberances 114 of the second vertical semi-cylindrical section 112 which provides the deep tissue massage to the back anatomy as shown in FIG. 2. In this manner, the massage mode can be changed between a smooth, less intense massage to a deep penetrating massage by merely physically rotating the cylindrical head 102 with the extended handle 104.

The extended handle 104 is approximately three-quarters inch in diameter, is approximately 9″-to-12″ in length and includes the smooth rounded tip 106 as shown in FIGS. 1 and 2. By utilizing the extended handle 104 to control the self-massaging apparatus 100, the cylindrical head 102 can be employed to “hammer” any muscle or muscle group in the back anatomy to provide direct massage. For example, the cylindrical head 102 can be employed in a “battering manner” by utilizing the smooth outer surface 110 of the first vertical semi-cylindrical section 108 to “hammer” a particular muscle. The descriptive terms of “to hammer” or “battering manner” refer to utilizing the extended handle 104 of the self-massaging apparatus 100 to maneuver the smooth outer surface 110 of the cylindrical head 102 to strike the muscle in the back anatomy to relieve pain. This action is accomplished much in the same way that one would strike a nail with a hammer. In the alternative, the smooth rounded tip 106 of the extended handle 104 is useful in addressing back pain caused by so called “trigger points”. In providing so called “trigger point massage”, the smooth rounded tip 106 at the distal free end of the extended handle 104 shown in FIGS. 1 and 2 is employed to directly apply pressure on a very small area of the back anatomy (typically approximately 0.5″ in diameter) that is in need of massage. This procedure usually involves the smooth rounded tip 106 being forcible applied to the back anatomy in an orthogonal manner (e.g., at right angles) and often requires the assistance of an additional person.

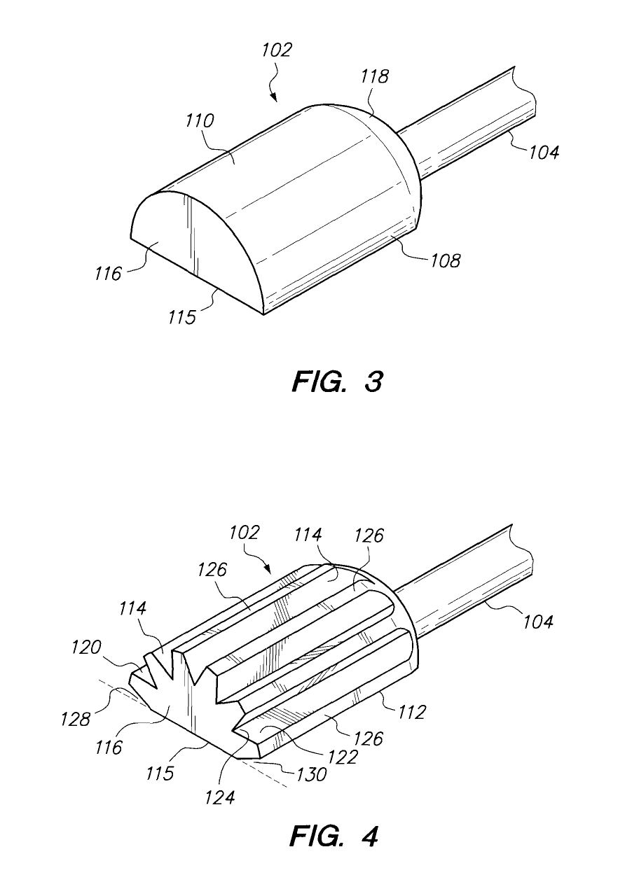

Let us turn our attention to the description of the cylindrical head 102 of the self-massaging apparatus 100 of the present invention. As noted, the cylindrical head 102 includes the first vertical semi-cylindrical section 108 and the second vertical semi-cylindrical section 112. If one imagines an invisible plane 115 passing vertically through the cylindrical head 102, one is left with the two halves which are illustrated by FIGS. 3 and 4. The first vertical semi-cylindrical section 108 illustrating the stationary smooth outer surface 110 and which is injection molded to the extended handle 104 is shown in FIG. 3. The second vertical semi-cylindrical section 112 illustrating the plurality of rows of stationary wedge-shaped protuberances 114 and which is injection molded to the extended handle 104 is shown in FIG. 4. The first vertical semi-cylindrical section 108 will be addressed first prior to discussing the second vertical semi-cylindrical section 112.

Now referring to FIGS. 1, 4, 5 and 6, the first vertical semi-cylindrical section 108 of the cylindrical head 102 is shown. This first vertical semi-cylindrical section 108 exhibits the stationary smooth outer surface 110 which appears as a solid half-cylinder in FIG. 3. The smooth outer surface 110 extends (1) the length of the first vertical semi-cylindrical section 108 and (2) for approximately one-hundred eighty mechanical degrees about the circumference of the first vertical semi-cylindrical section 108. This half cylindrical geometry is further illustrated by the flat bottom surface 116 located at the bottom of the cylindrical head 102 shown in FIGS. 3, 5 and 6. Further, the top of the stationary smooth outer surface 110 smoothly merges into an upper surface 118 as shown in FIGS. 1 and 3. The upper surface 118 is then fused to the extended handle 104 as shown in FIGS. 1 and 2 as by, for example, injection molding. The smooth upper surface 118 of the top of the stationary smooth outer surface 110 of the first vertical semi-cylindrical section 108 facilitates applying the self-massaging apparatus 100 to the back anatomy without pinching the skin.

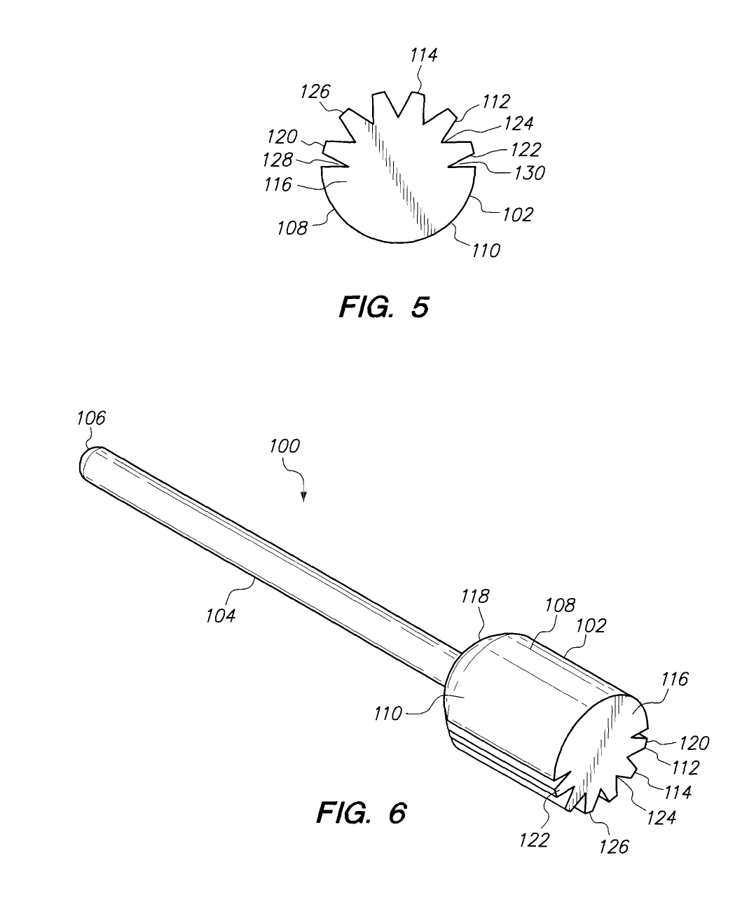

Now referring to FIGS. 2, 4, 5 and 6, the second vertical semi-cylindrical section 112 of the cylindrical head 102 is shown. This second vertical semi-cylindrical section 112 exhibits the plurality of rows of stationary wedge-shaped protuberances 114 best shown in FIGS. 2 and 4. The wedge-shaped protuberances 114 are formed on the opposite side of the smooth outer surface 110 of the first vertical semi-cylindrical section 108 as is shown in FIGS. 5 and 6. In the bottom plan view of the cylindrical head 102 shown in FIG. 5, the stationary smooth outer surface 110 is positioned beneath the stationary wedge-shaped protuberances 114. In the prospective view of FIG. 6, the stationary wedge-shaped protuberances 114 are positioned beneath the stationary smooth outer surface 110. The wedge-shaped protuberances 114 preferably comprise, for example, six protuberances 114 formed on the outer surface of the second vertical semi-cylindrical section 112 across the invisible plane 115 passing vertically through the cylindrical head 102. As with the stationary smooth outer surface 110, the wedge-shaped protuberances 114 extend approximately one-hundred eighty mechanical degrees across the circumference of the cylindrical head 102. Depending upon the total number of protuberances 114 and the size of the angles located between the invisible plane 115 passing vertically through the cylindrical head 102 and the two end protuberances 120 and 122, the size of the average angle 124 between adjacent protuberances appears to be within the range of twenty degrees-to-thirty degrees. The use of the wedge-shape for each of the protuberances 114 is preferred because the wedge-shaped design provides a stiffer more robust deep tissue massage when compared to conical-shaped designs. Further, each of the wedge-shaped protuberances 114 includes a flat top surface 126 which does not exhibit sharp edges, thus resulting in a higher comfort level when the wedge-shaped protuberances 114 are pressing on the human back anatomy. See Applicant's FIGS. 2, 4, 5 and 6.

Further explanation directed to the cylindrical head 102 will now be provided. It is noted that the inventive self-massaging apparatus 100 is manually-operated which distinguishes it from other massaging devices of the prior art that utilize any type of electrical or mechanical power source. Further, the two separate surfaces including the first vertical semi-cylindrical section 108 and the second vertical semi-cylindrical section 112 are stationary. In this context, the term “stationary” means that the smooth outer surface 110 and the wedge-shaped protuberances 114 are non-moveable. Specifically, as it relates to the wedge-shaped protuberances 114, the term “stationary” refers to the aspect that the protuberances 114 formed on the second vertical semi-cylindrical section 112 are molded into place and do not move. Consequently, during use of the self-massaging apparatus 100, the protuberances 114 will remain solid and robust to provide the deep tissue massage as anticipated. The protuberances 114 are of a “wedge-shaped” design to provide a stiffer, more robust deep tissue massage when compared to the conical-shaped designs of the past. Additionally, the top surface 126 of each wedge-shaped protuberance 114 is “flat” because {a} the flat top surfaces 126 do not include sharp edges to provide discomfort when the user is leaning or laying on the self-massaging apparatus 100 during use, {b} the flat top surfaces 126 of each wedge-shaped protuberance 114 provides deep thrust into the muscle tissue without causing damage like a pointed or sharp surface would cause, and {c} the flat top surfaces 126 cover more surface area on the human back anatomy during the massaging process.

In the exemplary embodiment of the self-massaging apparatus 100, six protuberances 114 are shown in FIGS. 2, 4, 5 and 6. Reference is made to FIG. 4 which indicates the six protuberances 114 and, in particular, the end protuberances 120 and 122. In FIG. 4 (as in FIG. 3), the invisible plane vertically bisecting the cylindrical head 102 is represented by the numeral 115. There are two angles formed between the end protuberances 120 and 122, respectively, and the invisible plane 115. That is to say, a first angle 128 is located between the invisible plane 115 and the first protuberance 120, and a second angle 130 is located between the invisible plane 115 and the second protuberance 122. In addition to the first angle 128 and the second angle 130, there are five additional angles located between the six wedge-shaped protuberances 114 of the exemplary embodiment shown in FIG. 4. The first angle 128 and the second angle 130 plus the five additional angles formed between the six protuberances 114 sum to a total of seven angles as shown in FIG. 4. If each of the angles were of the same size, the average angle would be 180 degrees (e.g., number of degrees in the invisible planar surface) divided by seven equivalent angles equaling 25.7 degrees each. In practice, the six wedge-shaped protuberances 114 having an average angular separation of 25.7 degrees between protuberances 114 is capable of covering a sufficient area when applied to the back muscles for massage.

In practice, the first angle 128 and the second angle 130 tend to be smaller than the five additional angles located between adjacent wedge-shaped protuberances 114. Consequently, depending on the size of the first angle 128 and the second angle 130, and the number of protuberances 114, the average size of each angle is typically between twenty degrees and thirty degrees. Further, experimentation has shown that six protuberances are optimal since it has been determined that maximizing the number of protuberances 114 while also ensuring sufficient angular separation between the protuberances 114 of the self-massaging apparatus 100 provides the most beneficial deep tissue massage. However, it is understood that a different number of wedge-shaped protuberances 114 having a different angular separation between the protuberances 114 can provide comparable beneficial effects.

In the preferred embodiment, the physical dimensions of the intersection of the cylindrical head 102 and the extended handle 104 are as follows. It is anticipated that the overall diameter of the cylindrical head 102 is two and one-quarter inches (2.25″) and thus the overall radius is one and an eighth inch (1.125″). On the second vertical semi-cylindrical section 112, each of the angles between adjacent wedge-shaped protuberances 114 located at the top of the cylindrical head 102 (on the side opposite to the upper surface 118 of the stationary smooth outer surface 110 shown in FIG. 1) is of the average angle size 124. Furthermore, each of the wedge-shaped protuberances 114 extends into the diameter of the cylindrical head 102 by three-eights of an inch (⅜″). Additionally, the diameter of the extended handle is three-quarters of an inch (¾″) and thus the radius of the extended handle is three-eights of an inch (⅜″). Thus, the dimension of solid material surrounding the top of the cylindrical head 102 on the side of the second vertical semi-cylindrical section 112 is three-eights of an inch ⅜″). This number was determined by the following simple equation applied to each of the radial dimensions of the cylindrical head 102:

Radius of cylindrical head 102 minus depth of average wedge angle 124 minus radius of extended handle 104 equals dimension of solid material on the side of the second vertical semi-cylindrical section 112. (1)

Translating this equation (1) into numerical values results in the following calculation.

1.125″−⅜″−⅜″= 9/8″− 3/8″− 3/8″= 3/8″ (2)

Thus, equation (2) shows that the dimension of solid material on the side of the second vertical semi-cylindrical section 112 of the cylindrical head 102 is ⅜″. By reviewing FIGS. 5 and 6, it is seen that this ⅜″ dimension determined in equation (2) above applies only to the second vertical semi-cylindrical section 112 which includes the wedge-shaped protuberances 114. The first vertical semi-cylindrical section 108 includes the stationary smooth outer surface 110, not the wedge-shaped protuberances 114. Additionally, the extended handle 104 is fused to the cylindrical head 102 in a unitary construction in the preferred embodiment. Consequently, because of the unitary construction, the ⅜″ radius of the extended handle 104 does contribute to structural stability and thus, on the side of the second vertical semi-cylindrical section 112, the following structural support dimension applies.

Resultant Dimension from Equation (2)+Radius of Extended Handle 104=⅜″+⅜″= 6/8″=¾″ (3)

Furthermore, the calculation shown in equation (2) above does not apply at all to the first vertical semi-cylindrical section 108 because that section does not include stationary wedge-shaped protuberances 114. Consequently, the full radius of 1.125″ of the cylindrical head 102 on the side of the first vertical semi-cylindrical section 108 shown in FIGS. 1 and 6 plus the dimension calculated in equation (3) provides structural support (e.g., 1.125″+¾″=1.125″+0.75″=1.875″ of solid material).

It is emphasized that the diameter of the cylindrical head 102 must be wide enough to raise the body being massaged sufficiently so that the wedge-shaped protuberances 114 can penetrate the skin and affect the muscle of the person being massaged. If the diameter of the cylindrical head 102 is too small, the self-massaging apparatus 100 will not be effective. Further, the diameter of the cylindrical head 102 cannot be too large since the self-massaging apparatus 100 will cease to be portable and will be ineffective in addressing small areas of the back anatomy. The diameter of the cylindrical head 102 must be at an optimal size to enable the rotating of the extended handle 104 to change the exposure of the cylindrical head 102 between the stationary smooth outer surface 110 and the rows of stationary wedge-shaped protuberances 114 when applied to the human back anatomy.

During use, the person utilizing the self-massaging apparatus 100 employs the extended handle 104 to position the cylindrical head 102 at the situs of the back pain. If a deep tissue massage is desired, the stationary wedge-shaped protuberances 114 of the cylindrical head 102 are aligned over the selected area of the back anatomy by utilizing the extended handle 104. The stationary smooth outer surface 110 of the first vertical semi-cylindrical section 108 can be placed for support against a piece of furniture, a bed or a wall surface (not shown). The user can now manipulate her movements and body weight and the extended handle 104 of the self-massaging apparatus 100 to massage the deep tissues located at the selected area of her back anatomy. The cylindrical head 102 can be caused to move horizontally or vertically on the back anatomy approximately three inches in either direction.

Thus, after the self-massaging apparatus 100 is positioned on the back anatomy, the user can move in either a forward of backward direction, or move from a right-to-left position (or visa versa) depending upon the position of the cylindrical head 102. In this manner, the stationary wedge-shaped protuberances 114 are applied to a specific area of the human back anatomy. The position of the cylindrical head 102 on the back anatomy must be changed by the user to accommodate a change in the direction of the movement of the cylindrical head 102 (and consequently the direction of the massage). If a more shallow, less intensive massage is desired, the extended handle 104 is employed to rotate the self-massaging apparatus 100 so that the smooth outer surface 110 of the first vertical semi-cylindrical section 108 is positioned against the back anatomy. Under these conditions, the wedge-shaped protuberances 114 of the second vertical semi-cylindrical section 112 are positioned against the furniture or wall surface (not shown). Once again, the user's body weight in combination with the extended handle 104 can be maneuvered in order to position the self-massaging apparatus 100 to the desired location of the user's back anatomy. Direct pressure and suitable movement of the user's body weight can then be applied so that the back anatomy traps the self-massaging apparatus 100 between the user and a piece of furniture to achieve the desired massaging result. Once again, the self-massaging apparatus 100 must be re-positioned by the user to change the direction of the massage. Note that the movements and maneuvering of the self-massaging apparatus 100 is accomplished by manual operation. Further, the smooth rounded tip 106 on the distal free end of the extended handle 104 is useful to provide a localized massage to pain trigger points located on the back anatomy. This action may require the assistance of a third party.

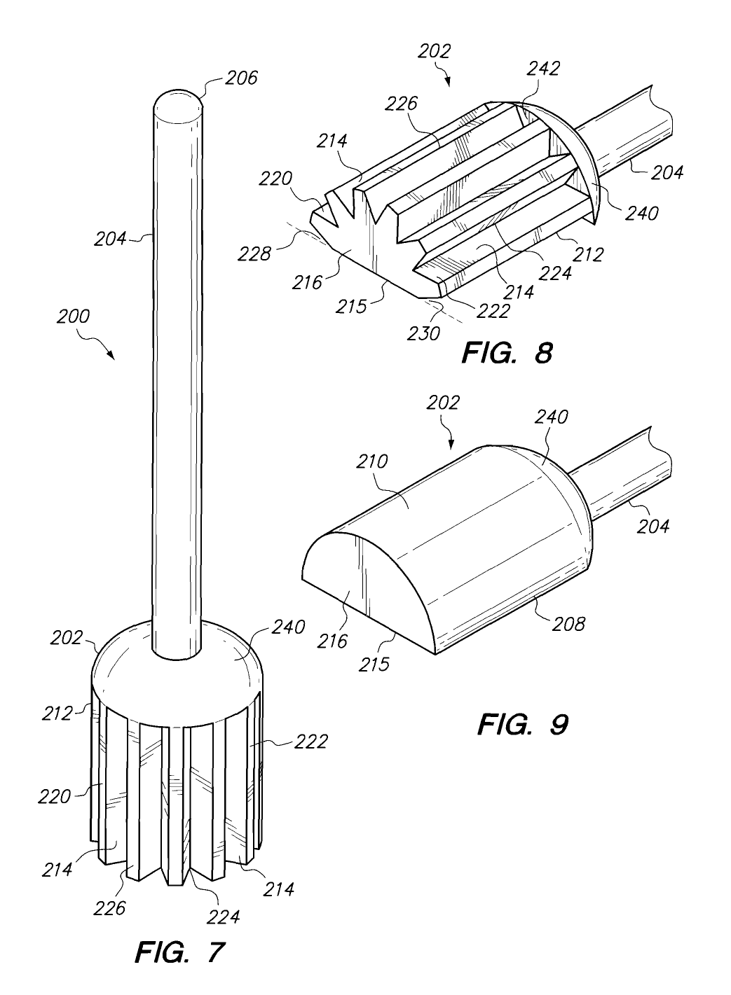

An alternative embodiment of the portable, manually-operated, self-massaging apparatus for use with the human back anatomy of the present invention identified by the general reference number 200 will now be disclosed. The alternative embodiment of the self-massaging apparatus 200 is shown in FIGS. 7-9. Each of the components of the alternative embodiment 200 which are duplicate to and perform the identical function as the corresponding component in the preferred embodiment 100 is identified by the corresponding number of the two-hundred series.

It is useful to compare the structure of the alternative embodiment 200 illustrated in FIGS. 7-9 with the structure of the preferred embodiment 100 illustrated in FIGS. 1-6. This comparison clearly shows that: {a} FIG. 2 and FIG. 7 are very similar; and {b} FIG. 4 and FIG. 8 are very similar; and finally {c} FIG. 3 and FIG. 9 are very similar. In fact, much of the structure of the alternative embodiment 200 is similar to the structure of the preferred embodiment 100. A distinguishing feature of the self-massaging apparatus 200 of the alternative embodiment is that the structure corresponding to the upper surface 118 of the preferred embodiment (shown best in FIGS. 1, 3 and 6 of the self-massaging apparatus 100) has been extended in the self-massaging apparatus 200. This means that the entire circumference of an upper surface 240 of a cylindrical head 202 of the self-massaging apparatus 200 of the alternative embodiment exhibits a smooth surface. Thus, when comparing the cylindrical head 202 of the self-massaging apparatus 200 with the cylindrical head 102 of the self-massaging apparatus 100, the smooth upper surface 240 is clearly a distinguishing feature as is shown when comparing FIG. 2 with FIG. 7, and when comparing FIG. 4 with FIG. 8. In contrast, the upper surface 118 of the cylindrical head 102 of the self-massaging apparatus 100 shown in FIG. 3 is very similar to the smooth upper surface 240 of the cylindrical head 202 of the self-massaging apparatus 200 shown in FIG. 9.

The self-massaging apparatus 200 of the alternative embodiment includes an extended handle 204 having a smooth rounded tip 206 on a distal free end thereof as is shown in FIG. 7. The extended handle 204 is connected to the cylindrical head 202 by, for example, injection molding for forming the unitary construction. The primary criteria is that the two components, the cylindrical head 202 and the extended handle 204, comprise a single member, that is, be of a unitary construction. The entire self-massaging apparatus 200 including the cylindrical head 202 and the extended handle 204 can be comprised of any of a suitable class of synthetic materials such as plastics which may be slightly flexible for shock absorption. The construction material should be fashioned from a firm material which may be slightly flexible. The firm material provides the cylindrical head 202 with the firmness necessary to apply adequate pressure to the back anatomy while also providing a slight flexibility to the extended handle 204. A slight flexibility to the extended handle 204 might be desirable in situations during which the extended handle 204 is utilized to strike the stationary smooth outer surface 210 of the first vertical semi-cylindrical section 208 of the cylindrical head 202 against the back anatomy. The slight flexibility in the extended handle 204 allows for shock absorption when the cylindrical head 202 is used to strike the back anatomy of a human being.

These fundamental requirements of the suitable material of the self-massaging apparatus 200 can be satisfied by any number of modern plastic materials which are amenable to mass production via injection molding or other similar methods. The requirement of a firm material exists because the self-massaging apparatus 200 is manipulated and positioned on the back anatomy by the extended handle 204 which is typically within the range of 9″-to-12″ in length. Thus, the extended handle 204 and the cylindrical head 202 must be fashioned from a suitable robust material with sufficient strength to withstand the vigorous massaging of the various difficult to reach body parts of the back anatomy. However, as in the preferred embodiment 100, the entire self-massaging apparatus 200 including the cylindrical head 202 and the extended handle 204 can be fashioned from other materials, for example, a suitable wood. The extended handle 204 enables the self-massaging apparatus 200 to be maneuvered not only to most areas of the back anatomy but is also utilized to rotate the cylindrical head 202 to change the massage mode. Reference to changing the massage mode refers to, for example, changing from the stationary smooth outer surface 210 of the first vertical semi-cylindrical section 208 which provides the less intensive massage to the back anatomy as shown in FIG. 9, to the rows of stationary wedge-shaped protuberances 214 of the second vertical semi-cylindrical section 212 which provides the deep tissue massage to the back anatomy as shown in FIGS. 7 and 8. In this manner, the massage mode can be changed between a smooth, less intense massage to a deep penetrating massage by merely physically rotating the cylindrical head 202 with the extended handle 204.

The extended handle 204 is approximately three-quarter inches in diameter, is approximately 9″-to-12″ in length and includes the smooth rounded tip 206 as shown in FIG. 7. By utilizing the extended handle 204 to control the self-massaging apparatus 200, the cylindrical head 202 can be employed to “hammer” any muscle or muscle group in the back anatomy to provide direct massage. For example, the cylindrical head 202 can be employed in a “battering manner” by utilizing the smooth outer surface 210 of the first vertical semi-cylindrical section 208 to “hammer” a particular muscle. The descriptive terms of “to hammer” or “battering manner” refer to utilizing the extended handle 204 of the self-massaging apparatus 200 to maneuver the smooth outer surface 210 of the cylindrical head 202 to strike the muscle in the back anatomy to relieve pain. This action is accomplished much in the same way that one would strike a nail with a hammer. In the alternative, the smooth rounded tip 206 of the extended handle 204 is useful in addressing back pain caused by so called “trigger points”. In providing so called “trigger point massage”, the smooth rounded tip 206 at the distal free end of the extended handle 204 shown in FIG. 7 is employed to directly apply pressure on a very small area of the back anatomy (typically approximately 0.5″ in diameter) that is in need of massage. This procedure usually involves the smooth rounded tip 206 being forcible applied to the back anatomy in an orthogonal manner (e.g., at right angles) and often requires the assistance of an additional person.

The unique construction of the portable, manually-operated, self-massaging apparatus 200 includes the cylindrical head 202 which consists of continuously formed but opposing vertical semi-cylindrical sections. By “continuously formed”, it is meant that the opposing vertical semi-cylindrical sections form a complete vertical cylinder having two separate but opposing faces. The semi-cylindrical sections include a first vertical semi-cylindrical section 208 having a stationary smooth outer surface 210 for facilitating a shallow, less intrusive massage as is clearly illustrated in FIG. 9. In contrast, an opposing second vertical semi-cylindrical section 212 has a plurality of rows of stationary wedge-shaped protuberances 214 as shown in FIGS. 7 and 8 that facilitate a deep tissue massage when applied to a human anatomy (not shown). If one imagines an invisible plane 215 passing vertically through the cylindrical head 202, one is left with the two halves which are illustrated by FIGS. 8 and 9. The first vertical semi-cylindrical section 208 illustrating the stationary smooth outer surface 210 and which is injection molded to the extended handle 204 is shown in FIG. 9. The second vertical semi-cylindrical section 212 illustrating the plurality of rows of stationary wedge-shaped protuberances 214 and which is injection molded to the extended handle 204 is shown in FIGS. 7 and 8. The first vertical semi-cylindrical section 208 will be addressed first prior to discussing the second vertical semi-cylindrical section 212.

Now referring to FIG. 9, the first vertical semi-cylindrical section 208 of the cylindrical head 202 is shown. This first vertical semi-cylindrical section 208 exhibits the stationary smooth outer surface 210 which appears as a solid half-cylinder in FIG. 9. The smooth outer surface 210 extends (1) the length of the first vertical semi-cylindrical section 208 and (2) for approximately one-hundred eighty mechanical degrees about the circumference of the first vertical semi-cylindrical section 208. This half cylindrical geometry is further illustrated by the flat bottom surface 216 located at the bottom of the cylindrical head 202 shown in FIG. 9. Further, the top of the stationary smooth outer surface 210 of the first vertical semi-cylindrical section 208 smoothly merges into the smooth upper surface 240 as shown in FIG. 9. The smooth upper surface 240 is then fused to the extended handle 204 (as shown in FIG. 7) as by, for example, injection molding. The smooth upper surface 240 of the top of the stationary smooth outer surface 210 of the first vertical semi-cylindrical section 208 facilitates applying the self-massaging apparatus 200 to the back anatomy without pinching the skin.

Now referring to FIGS. 7 and 8, the second vertical semi-cylindrical section 212 of the cylindrical head 202 is shown. This second vertical semi-cylindrical section 212 exhibits the plurality of rows of stationary wedge-shaped protuberances 214 best shown in FIG. 8. The wedge-shaped protuberances 214 are formed on the opposite side of the smooth outer surface 210 of the first vertical semi-cylindrical section 208 as is shown in FIG. 9. The wedge-shaped protuberances 214 preferably comprise, for example, six protuberances 214 formed on the outer surface of the second vertical semi-cylindrical section 212 across the invisible plane 215 passing vertically through the cylindrical head 202. As with the stationary smooth outer surface 210, the wedge-shaped protuberances 214 extend approximately one-hundred eighty mechanical degrees across the circumference of the cylindrical head 202. Depending upon the total number of protuberances 214 and the size of the angles located between the invisible plane 215 passing vertically through the cylindrical head 202 and the two end protuberances 220 and 222, the size of the average angle 224 between adjacent protuberances appears to be within the range of twenty degrees-to-thirty degrees. The use of the wedge-shape for each of the protuberances 214 is preferred because the wedge-shaped design provides a stiffer more robust deep tissue massage when compared to conical-shaped designs. Further, each of the wedge-shaped protuberances 214 includes a flat top surface 226 which does not exhibit sharp edges, and thus results in a higher comfort level when the wedge-shaped protuberances 214 are pressing on the human back anatomy. See Applicant's FIGS. 7 and 8.

Further explanation directed to the cylindrical head 202 will now be provided. It is noted that the inventive self-massaging apparatus 200 is manually-operated which distinguishes it from other massaging devices of the prior art that utilize any type of electrical or mechanical power source. Further, the two separate surfaces including the first vertical semi-cylindrical section 208 and the second vertical semi-cylindrical section 212 are stationary. In this context, the term “stationary” means that the smooth outer surface 210 and the wedge-shaped protuberances 214 are non-moveable. Specifically, as it relates to the wedge-shaped protuberances 214, the term “stationary” refers to the aspect that the protuberances 214 formed on the second vertical semi-cylindrical section 212 are molded into place and do not move. Consequently, during use of the self-massaging apparatus 200, the protuberances 214 will remain solid and robust to provide the deep tissue massage as anticipated. The protuberances 214 are of a “wedge-shaped” design to provide a stiffer, more robust deep tissue massage when compared to the conical-shaped designs of the past. Additionally, the top surface 226 of each wedge-shaped protuberance 214 is “flat” because {a} the flat top surfaces 226 do not include sharp edges to provide discomfort when the user is leaning or laying on the self-massaging apparatus 200 during use, {b} the flat top surfaces 226 of each wedge-shaped protuberance 214 provides deep thrust into the muscle tissue without causing damage like a pointed or sharp surface would cause, and {c} the flat top surfaces 226 cover more surface area on the human back anatomy during the massaging process.

In the exemplary embodiment of the self-massaging apparatus 200, six protuberances 214 are shown in FIGS. 7 and 8. Reference is made to FIG. 8 which indicates the six protuberances 214 and, in particular, the end protuberances 220 and 222. In FIG. 8 (as in FIG. 9), the invisible plane vertically bisecting the cylindrical head 202 is represented by the numeral 215. There are two angles formed between the end protuberances 220 and 222, respectively, and the invisible plane 215. That is to say, a first angle 228 is located between the invisible plane 215 and the first protuberance 220, and a second angle 230 is located between the invisible plane 215 and the second protuberance 222. In addition to the first angle 228 and the second angle 230, there are five additional angles located between the six wedge-shaped protuberances 214 of the exemplary embodiment shown in FIG. 8. The first angle 228 and the second angle 230 plus the five additional angles formed between the six protuberances 214 sum to a total of seven angles as shown in FIG. 8. If each of the angles were of the same size, the average angle would be 180 degrees (e.g., number of degrees in the invisible planar surface) divided by seven equivalent angles equaling 25.7 degrees each. In practice, the six wedge-shaped protuberances 214 having an average angular separation of 25.7 degrees between protuberances 214 are capable of covering a sufficient area when applied to the back muscles for massage.

In practice, the first angle 228 and the second angle 230 tend to be smaller than the five additional angles formed between adjacent wedge-shaped protuberances 214. Consequently, depending on the size of the first angle 228 and the second angle 230, and the number of protuberances 214, the average size of each angle is typically between twenty degrees and thirty degrees. Further, experimentation has shown that six protuberances are optimal since it has been determined that maximizing the number of protuberances 214 while also ensuring sufficient angular separation between the protuberances 214 of the self-massaging apparatus 200 provides the most beneficial deep tissue massage. However, it is understood that a different number of wedge-shaped protuberances 214 having a different angular separation between the protuberances 214 can provide comparable beneficial effects.

In the self-massaging apparatus 200 of the alternative embodiment, the entire upper surface of the cylindrical head 202 comprises the smooth upper surface 240 as is shown in FIGS. 7-9. In the preferred embodiment, the self-massaging apparatus 100 includes the upper surface 118 that smoothly transitions with the top of the stationary smooth outer surface 110 of the first vertical semi-cylindrical section 108. However, the stationary wedge-shaped protuberances 114 of the second vertical semi-cylindrical section 112 includes the average angle size 124 between the protuberances 114 shown in FIGS. 2 and 4. Thus, in the preferred embodiment, there is no smooth transition between the second vertical semi-cylindrical section 112 and the top of the cylindrical head 102. However, in the alternative embodiment, both FIGS. 7 and 8 of the self-massaging apparatus 200 clearly show that the top of the cylindrical head 202 includes the smooth upper surface 240. The smooth upper surface 240 enables both {a} the wedge-shaped protuberances 214 of the second vertical semi-cylindrical section 212 shown in FIGS. 7 and 8, and {b} the stationary smooth outer surface 210 of the first vertical semi-cylindrical section 208 shown in FIG. 9, to smoothly transition into the top surface of the cylindrical head 202. As a result, a user can utilize the top of the cylindrical head 202, i.e., the smooth upper surface 240, to massage the upper back anatomy and the neck region with pinching the skin thereof.

The construction shown in FIG. 9 of the self-massaging apparatus 200 of the alternative embodiment is very similar to the construction shown in FIG. 3 of the self-massaging apparatus 100 of the preferred embodiment. As can be seen in FIG. 9, the stationary smooth outer surface 210 smoothly cooperates and curves into the smooth upper surface 240. Consequently, the radius of the smooth upper surface 240 above the first vertical semi-cylindrical section 208 plus the radius of the extended handle 204 (which is fused in unitary construction with the cylindrical head 202) sums to one and one-eight inches (1.125″). Thus, the entire radius of the first vertical semi-cylindrical section 208 is available for structurally supporting the self-massaging apparatus 200.

The construction of the second vertical semi-cylindrical section 212 of the alternative embodiment 200 shown in FIGS. 7 and 8 differs from the construction of the second vertical semi-cylindrical section 112 of the preferred embodiment 100 shown in FIGS. 2 and 4. In the cylindrical head 102 of the preferred embodiment 100, the wedge-shaped protuberances 114 and their corresponding average angle size 124 extend well into the top of the cylindrical head 102. However, in the cylindrical head 202 of the alternative embodiment 200, the plurality of rows of stationary wedge-shaped protuberances 214 terminate at the underneath surface 242 of the smooth upper surface 240 as is clearly shown in FIG. 8. In the exemplary self-massaging apparatus 200, each of the six wedge-shaped protuberances 214 terminate and are fused, as by injection molding, to the underneath surface 242 of the smooth upper surface 240 (in the same mariner as the extended handle 204 is fused in unitary construction to the cylindrical head 202). This construction {a} provides the plurality of wedge-shaped protuberances 214 that are utilized to provide the deep tissue massage on the human back anatomy in the same manner as that described in the preferred embodiment, and {b} provides the smooth upper surface 240 for the entire top of the cylindrical head 202 as is shown in FIG. 7.

As can be seen in FIG. 7, and also in FIG. 8, the plurality of wedge-shaped protuberances 214 also cooperates with the transition from the second vertical semi-cylindrical section 212 to the smooth upper surface 240. There is no interruption caused by angles formed between the wedge-shaped protuberances 214. Consequently, the radius of the smooth upper surface 240 above the second vertical semi-cylindrical section 212 plus the radius of the extended handle 204 (which is fused in unitary construction with the cylindrical head 202) also sums to one and one-eight inches (1.125″). Thus, as with the first vertical semi-cylindrical section 208, the entire radius of the second vertical semi-cylindrical section 212 is available for structurally supporting the self-massaging apparatus 200. Therefore, the entire 1.125″ radius of the smooth upper surface 240 positioned above the first vertical semi-cylindrical section 208 plus the entire 1.125″ radius of the smooth upper surface 240 positioned above the second vertical semi-cylindrical section 212 sums to a 2.25″ diameter available for structurally supporting the self-messaging apparatus 200 as set forth in equation (4) immediately below.

Dimension of Structural Support for Self-Massaging Apparatus 200 Equals the Two Contributions of the Smooth Upper Surface 240 Above 1^{st} Vertical Semi-Cylindrical Section 208+2^{nd} Vertical Semi-Cylindrical Section 212=One and One-Eighth Inches (1.125″)+One and One-Eighth Inches (1.125″)=Total=Two and One-Quarter Inches (2.25″) (4)

During use, the person utilizing the self-massaging apparatus 200 employs the extended handle 204 to position the cylindrical head 202 at the situs of the back pain. If a deep tissue massage is desired, the stationary wedge-shaped protuberances 214 of the cylindrical head 202 are aligned over the selected area of the back anatomy by utilizing the extended handle 204. The stationary smooth outer surface 210 of the first vertical semi-cylindrical section 208 can be placed for support against a piece of furniture, a bed or a wall surface (not shown). The user can now manipulate her movements and body weight and the extended handle 204 of the self-massaging apparatus 200 to massage the deep tissues located at the selected area of her back anatomy. The cylindrical head 202 can be caused to move horizontally or vertically on the back anatomy approximately three inches in either direction.

Thus, after the self-massaging apparatus 200 is positioned on the back anatomy, the user can move in either a forward of backward direction, or move from a right-to-left position (or visa versa) depending upon the position of the cylindrical head 202. In this manner, the stationary wedge-shaped protuberances 214 are applied to a specific area of the human back anatomy. The position of the cylindrical head 202 on the back anatomy must be changed by the user to accommodate a change in the direction of the movement of the cylindrical head 202 (and consequently the direction of the massage). If a more shallow, less intensive massage is desired, the extended handle 204 is employed to rotate the self-massaging apparatus 200 so that the smooth outer surface 210 of the first vertical semi-cylindrical section 208 is positioned against the back anatomy. Under these conditions, the wedge-shaped protuberances 214 of the second vertical semi-cylindrical section 212 are positioned against the furniture or wall surface (not shown). Once again, the user's body weight in combination with the extended handle 204 can be maneuvered in order to position the self-massaging apparatus 200 to the desired location of the user's back anatomy. Direct pressure and suitable movement of the user's body weight can then be applied so that the back anatomy traps the self-massaging apparatus 200 between the user and a piece of furniture to achieve the desired massaging result. Once again, the self-massaging apparatus 200 must be re-positioned by the user to change the direction of the massage. Note that the movements and maneuvering of the self-massaging apparatus 200 is accomplished by manual operation. Further, the smooth rounded tip 206 on the distal free end of the extended handle 204 is useful to provide a localized massage to pain trigger points located on the back anatomy. This action may require the assistance of a third party.

Thus, the preferred embodiment of the present invention is directed to a portable, manually-operated, self-massaging apparatus 100 for use on a human back anatomy (not shown). The self-massaging apparatus 100 includes a cylindrical head 102 having a first vertical semi-cylindrical section 108 continuously formed with a second vertical semi-cylindrical section 112. An extended handle 104 is connected to the cylindrical head 102 of the self-massaging apparatus 100 for forming a unitary construction. The extended handle 104 includes a smooth rounded tip 106 for providing a localized massage directly at a pain trigger point of the human back anatomy. The first vertical semi-cylindrical section 108 includes a stationary smooth outer surface 110 for providing a shallow, less intensive massage. The second vertical semi-cylindrical section 112 includes a plurality of rows of stationary wedge-shaped protuberances 114 with each protuberance 114 having a flat top surface 126 for providing a deep tissue massage when applied to a human back anatomy. An alternative embodiment of the self-massaging apparatus 200 includes a cylindrical head 202 having opposing vertical surfaces including a first vertical semi-cylindrical section 208 having a stationary smooth outer surface 210 for providing a shallow, less intensive massage, and a second vertical semi-cylindrical section 212 having a plurality of rows of stationary wedge-shaped protuberances 214 for providing a more robust deep tissue massage. Further, the cylindrical head 202 is connected, as by injection molding, to an extended handle 204 for providing a unitary construction. In the alternative embodiment, the entire top surface of the cylindrical head 202 exhibits a smooth upper surface 240 to facilitate massage of the neck and upper back area of the human back anatomy without pinching the skin of the user. The wedge-shaped protuberances 214 terminate at an underneath surface 242 of the smooth upper surface 240.

The present invention provides novel advantages over other massaging apparatus designs known in the prior art. A main advantage of the portable, manually-operated, self-massaging apparatus 100 for use on the human back anatomy is (1) the self-massaging apparatus 100 is portable, and (2) it is manually-operated wherein most locations of the human back anatomy can be reached utilizing (3) an extended handle 104 having a length within the range of 9″-12″, and including (4) a smooth rounded tip 106 located at a distal free end for use in providing a “trigger point massage” at an acute pain point. Additionally, the cylindrical head 102 comprises dual semi-cylindrical surfaces including (5) a first vertical semi-cylindrical section 108 having a stationary smooth outer surface 110 for providing a more shallow, less intense massage, and (6) a plurality of rows of stationary wedge-shaped protuberances 114 where each protuberance 114 includes a flat top surface 126 for providing a robust, deep tissue massage. The self-massaging apparatus 100 is easily employed by (7) using the extended handle 104 to position the cylindrical head 102 to a situs of the pain on the back anatomy and (8) trapping the cylindrical head 102 between the back anatomy and, for example, an article of furniture at which point pressure can be applied to the back anatomy to relieve the pain. If desired, (9) the mode of massage can be changed by rotating the extended handle 104 which rotates the cylindrical head 102 for switching from a deep tissue massage to a less intensive massage or visa versa. Additionally, (10) the extended handle 104 can be used to “batter” or “hammer” a particular muscle in the back anatomy with the cylindrical head 102 to relieve pain. In an alternative embodiment of the self-massaging apparatus 200, the (11) top surface of the cylindrical head 202 includes a smooth upper surface 240 to enable the massaging of the upper back and neck region without pinching the skin of the user.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility. It is therefore intended by the appended claims to cover any and all such modifications, applications and embodiments within the scope of the present invention. Accordingly,

What is claimed is:

1. A portable, manually-operated, self-massaging apparatus for use on a human anatomy comprising:
a cylindrical head having a first vertical semi-cylindrical section continuously formed with a second vertical semi-cylindrical section;
a handle connected to said cylindrical head for forming a unitary construction;
wherein said first vertical semi-cylindrical section includes a stationary smooth outer surface for providing a shallow, less intensive massage; and
wherein said second vertical semi-cylindrical section includes a plurality of rows of stationary wedge-shaped protuberances with each protuberance having a flat top for providing a deep tissue massage when applied to a human anatomy.

2. The self-massaging apparatus of claim 1 wherein said handle is an extended handle.

3. The self-massaging apparatus of claim 1 wherein said handle is connected to said cylindrical head by injection molding.

4. The self-massaging apparatus of claim 1 wherein said cylindrical head is rounded at a vertical top of said cylindrical head for providing a smooth transition across said human anatomy.

5. The self-massaging apparatus of claim 1 wherein each protuberance of said rows of stationary wedge-shaped protuberances are separated from each adjacent protuberance by an angle within a range of twenty degrees-to-thirty degrees.

6. A portable, manually-operated, self-massaging apparatus for use on a human back anatomy comprising:
a cylindrical head having a first vertical semi-cylindrical section continuously formed with a second vertical semi-cylindrical section;
a handle connected to said cylindrical head for forming a unitary construction, said handle having a smooth rounded tip for providing a localized massage;
wherein said first vertical semi-cylindrical section includes a stationary smooth outer surface for providing a shallow, less intensive massage; and
wherein said second vertical semi-cylindrical section includes a plurality of to rows of stationary wedge-shaped protuberances with each protuberance having a flat top for providing a deep tissue massage when applied to a human back anatomy.

7. A portable, manually-operated, self-massaging apparatus for use on a human back anatomy comprising:
a cylindrical head having a smooth upper surface, and a first vertical semi-cylindrical section continuously formed with a second vertical semi-cylindrical section;
a handle connected to said cylindrical head for forming a unitary construction;
wherein said first vertical semi-cylindrical section includes a stationary smooth outer surface for providing a shallow, less intensive massage; and
wherein said second vertical semi-cylindrical section includes a plurality of rows of stationary wedge-shaped protuberances with each protuberance having a flat top for providing a deep tissue massage when applied to a human back anatomy.
